(19) United States
(12) Patent Application Publication
(10) Pub. No.: US 2025/0315224 A1
(43) Pub. Date: Oct. 9, 2025

(54) INFORMATION PROCESSING SYSTEM, INFORMATION PROCESSING APPARATUS INFORMATION PROCESSING METHOD, AND PROGRAM

(71) Applicant: LAKEEL, INC., Tokyo (JP)

(72) Inventors: Yoshiaki KAWAKAMI, Tokyo (JP); Jun OYA, Tokyo (JP)

(73) Assignee: LAKEEL, INC., Tokyo (JP)

(21) Appl. No.: 19/243,994

(22) Filed: Jun. 20, 2025

Related U.S. Application Data
(63) Continuation of application No. 17/605,810, filed on Oct. 22, 2021, now abandoned.

(30) Foreign Application Priority Data
Apr. 23, 2019 (JP) 2019-082311

(51) Int. Cl. G06F 8/36; H04L 67/51

(52) U.S. Cl. CPC G06F 8/36; H04L 67/51

(57) ABSTRACT

An information processing system, which provides services in cooperation with a cloud system, includes element accumulation means for accumulating an element included in a page for providing a service on the cloud system, page-data generating means for generating a page for a new service by using the element accumulated by the element accumulation means, and element-program execution means for executing a program associated with the element included in the page.

### CROSS REFERENCE

This is a Continuation application of U.S. application Ser. No. 17/605,810, filed Oct. 22, 2021, which is a U. S. National Phase application under 35 USC 371 of International Application PCT/JP2020/017561, filed Apr. 23, 2020, which claims the benefit of priority of Japanese Patent Application No. 2019-082311, filed Apr. 23, 2019, the entire contents of all of which are incorporated herein by reference.

### TECHNICAL FIELD

The present invention relates to an information processing system, information processing apparatuses, an information processing method, and a program.

### BACKGROUND ART

In recent years, the speed of the progress and the environmental change of IT (Information Technology), mainly in cloud technology, has increased dramatically. This trend is expected to accelerate in the future.

Under such circumstances, it is required that the latest IT technology be grasped quickly for utilization so as to respond to changes in business quickly and to contribute the departments such as operation departments.

Patent Literature 1 discloses a technique for assisting in changing the design of an IT service system.

The technique described in Patent Literature 1 aims to automatically determine design points which need to be reviewed in the architecture in terms of a change in quality requirements that produces across-architecture effects and that is demanded by a stakeholder.

### CITATION LIST

### Patent Literature

Patent Literature 1: Japanese Unexamined Patent Application, Publication No. 2019-015995

### SUMMARY OF INVENTION

### Technical Problem

Under the circumstances described above, more rapid, flexible construction of functions in an information processing system is required. However, the technique of the related art does not satisfy this requirement.

An issue of the present invention is to construct functions in an information processing system more rapidly and flexibly.

### Solution to Problem

In order to achieve the object described above, an information processing system according to an aspect of the present invention comprising:
an information processing system providing services in cooperation with a cloud system, the information processing system comprising:
element accumulation means for accumulating an element included in a page for providing a service on the cloud system;
page-data generating means for generating a page for a new service by using the element accumulated by the element accumulation means; and
element-program execution means for executing a program associated with the element included in the page.

### Advantageous Effects of Invention

The present invention enables more rapid, flexible construction of functions in an information processing system.

### BRIEF DESCRIPTION OF DRAWINGS

FIG. 1 is a schematic diagram illustrating the system configuration of the entirety of an information processing system 1 according to the present invention.

FIG. 2 is a schematic diagram illustrating the functional configuration of the information processing system 1.

FIG. 3 is a diagram illustrating the hardware configuration of an information processing apparatus 800 configuring each apparatus.

FIG. 4 is a block diagram illustrating the functional configuration of the service development terminal 10.

FIG. 5 is a schematic diagram illustrating an exemplary UI screen displaying a list of programs for providing services, which are stored in the service repository 522.

FIG. 6 is a block diagram illustrating the functional configuration of the widget development terminal 20.

FIG. 7 is a schematic diagram illustrating an exemplary UI screen displaying a list of widgets stored in the widget repository 621.

FIG. 8 is a schematic diagram illustrating the relationship between a widget and a service corresponding to the widget.

FIG. 9 is a schematic diagram illustrating data for defining a widget.

FIG. 10 is a block diagram illustrating the functional configuration of the operator/administrator terminal 30.

FIG. 11 is a schematic diagram illustrating an exemplary UI screen for indicating a process of creation of a page.

FIG. 12 is a block diagram illustrating the functional configuration of the end-user terminal 40.

FIG. 13 is a block diagram illustrating the functional configuration of the service providing server 50.

FIG. 14 is a block diagram illustrating the functional configuration of the component providing server 60.

FIG. 15 is a flowchart of a service development process performed by the service development terminal 10.

FIG. 16 is a flowchart of a widget development process performed by the widget development terminal 20.

FIG. 17 is a flowchart of a page edit process performed by the operator/administrator terminal 30.

FIG. 18 is a flowchart of a service use process performed by the end-user terminal 40.

FIG. 19 is a flowchart of a component creation receiving process performed by the component providing server 60.

FIG. 20 is a flowchart of a page creation receiving process performed by the component providing server 60.

FIG. 21 is a flowchart of a page providing process performed by the service providing server 50.

FIG. 22 is a flowchart of a service creation receiving process performed by the service providing server 50.

FIG. 23 is a flowchart of a service receiving process performed by the service providing server 50.

FIG. 24 is a flowchart of a data analysis process performed by the service providing server 50.

FIG. 25 is a schematic diagram illustrating an exemplary user interface for designing a service flow by combining components.

FIG. 26 is a flowchart of a page-data drawing process performed by the end-user terminal 40.

FIG. 27 is a flowchart of the service providing process performed by the service providing server 50.

### DESCRIPTION OF EMBODIMENTS

An embodiment of the present invention will be described below by referring to the drawings.

### [Configuration]

### [System Configuration]

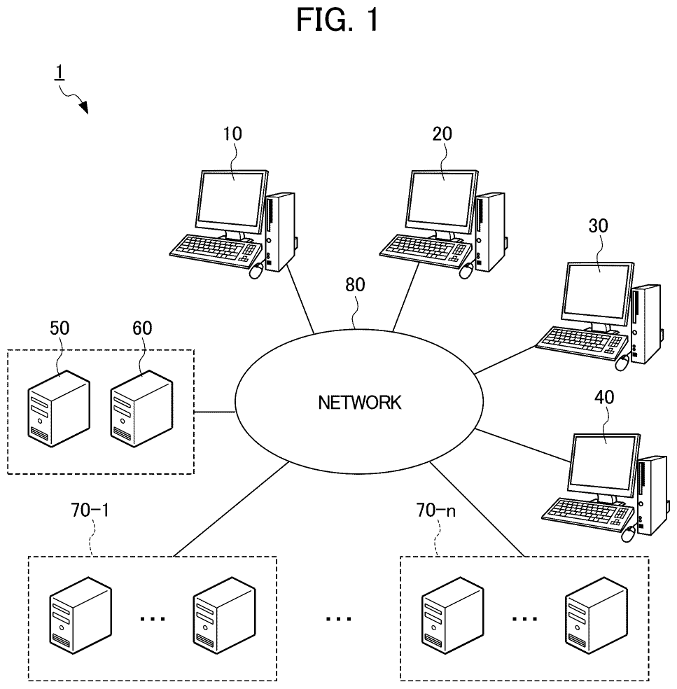

FIG. 1 is a schematic diagram illustrating the system configuration of the entirety of an information processing system 1 according to the present invention.

The information processing system 1, which is a system providing services in cooperation with multiple types of cloud systems, is constructed based on a DevOps environment (a system environment in which development closely cooperates with operation). The information processing system 1 accumulates, for example, widgets, which serve as elements embedded in pages for providing services, and programs for services for implementing widget actions. Through reuse of the accumulated widgets and programs for services, the information processing system 1 enables construction of pages for providing new services.

Therefore, in construction of pages for providing new services, the pages for the necessary services may be constructed simply and flexibly by selecting elements necessary for the services and embedding the selected elements in the pages.

That is, the information processing system 1 according to the present embodiment enables functions of an information processing system to be constructed more rapidly and flexibly.

As illustrated in FIG. 1, the information processing system 1 includes a service development terminal 10, a widget development terminal 20, an operator/administrator terminal 30, an end-user terminal 40, a service providing server 50, and a component providing server 60. In addition, the information processing system 1 is capable of cooperating with cloud systems 70-1 to 70-n (where n is a natural number). The service development terminal 10, the widget development terminal 20, the operator/administrator terminal 30, the end-user terminal 40, the service providing server 50, the component providing server 60, and the cloud systems 70-1 to 70-n are capable of communicating with each other over a network 80.

In the information processing system 1 according to the present embodiment, dynamic components and static components are prepared as elements embedded in pages for providing services. The dynamic components indicate page elements whose display is changed in cooperation with the service providing server 50. For example, the dynamic components are small-size programs typified by widgets. The static components are various types of elements which are not the dynamic components. For example, the static components are content data and media data whose content is fixed. An HTML (HyperText Markup Language) file, whose description is fixed, may be used as an example of content data whose content is fixed. Still image data, movie data, music data or banner data may be used as an example of media data. The dynamic components and the static components, which are components disposed on screens, are collectively called “screen components” appropriately.

The service development terminal 10 is used by a developer who develops programs for providing services corresponding to widgets. Programs for providing services corresponding to widgets, which are developed on the widget development terminal 20, are developed on the service development terminal 10. In the present embodiment, programs for services that have been already developed are accumulated in the service providing server 50. In development of a program for providing a service, the already developed service programs may be reused.

The widget development terminal 20 is used by a developer who develops widgets serving as elements of pages for providing services. Widgets embedded in pages, which are created on the operator/administrator terminal 30, are developed on the widget development terminal 20. In the present embodiment, widgets that have been already developed are accumulated in the component providing server 60. In development of a widget, the already developed widgets may be reused.

The operator/administrator terminal 30 is used by a creator (an operator, an administrator, or the like of services) who creates pages for providing services. In the present embodiment, elements (for example, widgets, content, or media) for constructing services are accumulated in the component providing server 60. On the operator/administrator terminal 30, pages for providing services are created by selecting elements for constructing services and embedding the selected elements in pages.

The end-user terminal 40 is used by an end user. When the end user selects a target page, the end-user terminal 40 downloads the page data from the service providing server 50, and displays the elements included in the page. At that time, when the page includes widgets, the end-user terminal 40 executes the widgets to access the service providing server 50, and obtains the execution results of the services corresponding to the widgets to display the page.

The service providing server 50 includes a repository (a service development repository 521 described below), a repository (a service repository 522 described below), and a database (a history database 523 described below). The service development repository 521 stores programs, for providing services, that are being developed on the service development terminal 10. The service repository 522 stores released programs for providing services. The history database 523 stores history data obtained through provision of services. The service providing server 50 obtains a service program that is being developed on the service development terminal 10, every predetermined time (for example, every minute), and stores the obtained program in the repository (service development repository 521). The service providing server 50 obtains service programs that are completed on the service development terminal 10, and stores the obtained programs in the repository (service repository 522). The completed service programs are stored in the repository (service repository 522), and are thus released. Data (released data) of pages for providing services, which are created on the operator/administrator terminal 30, is stored in the service repository 522. For example, page data stored in the service repository 522 may be obtained from a page repository 625 of the component providing server 60. In addition, data of pages completed on the operator/administrator terminal 30 may be obtained as page data stored in the service repository 522. In response to a request for page data, the service providing server 50 transmits the page data to the request source. Data of pages for providing services may be stored in a different server (for example, another server in the information processing system 1 or a different server among the cloud systems 70-1 to 70-n) installed to provide page data to end users. In response to a request for use of a service as an API (Application Programming Interface), the service providing server 50 executes the program for the service, and transmits the execution result data to the request source. In addition, in provision of a service, the service providing server 50 obtains various types of history data, and stores the various types of obtained history data in the database (history database 523). The service providing server 50 analyzes the trend and characteristics of the history data stored in the database, and generates application examples of new services in which the analyzed trend and characteristics are utilized. In addition, the service providing server 50 proposes the generated application examples of new services to a developer, who uses the service development terminal 10, or a developer, who uses the widget development terminal 20.

The component providing server 60 includes repositories (a widget repository 621, a content repository 622, and a medium repository 623 which are described below) storing widgets, content, and media, which serve as components (screen components) included in pages. In addition, the component providing server 60 includes a repository (a component development repository 624 described below), which stores components (widgets) that are being developed on the widget development terminal 20, and a repository (the page repository 625 described below), which stores released pages for providing services. The component providing server 60 obtains a widget that is being developed on the widget development terminal 20, every predetermined time (for example, every minute), and stores the obtained widget in the repository (component development repository 624). The component providing server 60 obtains data of pages completed on the operator/administrator terminal 30, and stores the obtained page data in the repository (page repository 625). Data of completed pages is stored in the repository (page repository 625), and the pages are thus released. The data of released pages may be reused as components. In response to a request for page data, the component providing server 60 transmits the page data to the request source.

The cloud systems 70-1 to 70-n are cloud systems formed of multiple server groups. In the present embodiment, cloud systems, which are operated by operating entities different from the operating entity of the information processing system 1, may be used as the cloud systems 70-1 to 70-n. That is, in the present embodiment, the information processing system 1 is capable of cooperating with multiple types of cloud systems. The information processing system 1 absorbs the difference between the types of cloud system, and provides services using cloud native applications on a DevOps environment.

The service providing server 50 and the component providing server 60 described above may have either one of the following configurations: a configuration in which the service providing server 50 and the component providing server 60 operate as any server among the cloud systems 70-1 to 70-n; a configuration in which the service providing server 50 and the component providing server 60 operate as a server installed separately from the cloud systems 70-1 to 70-n.

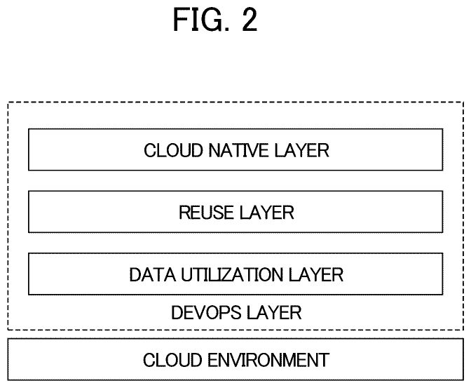

FIG. 2 is a schematic diagram illustrating the functional configuration of the information processing system 1.

As illustrated in FIG. 2, the information processing system 1, which is constructed on a cloud environment, cooperates with the cloud systems 70-1 to 70-n included in the cloud environment. In a development environment according to DevOps, the information processing system 1 is provided with the functions of a cloud native layer, a reuse layer, and a data utilization layer.

In the cloud native layer, pages for various types of services are viewed on the end-user terminal 40. Thus, programs for components (for example, widgets) operating on the cloud environment are executed.

The reuse layer provides a development environment in which widgets, which serve as page elements for providing various types of services, and programs for providing services corresponding to widgets are reused.

In the data utilization layer, the trend and characteristics of history data obtained through provision of various types of services are analyzed, and new services utilizing the analyzed trend and characteristics are generated.

### [Hardware Configuration]

The hardware configuration of each apparatus in the information processing system 1 will be described. In the information processing system 1, each apparatus is configured by using an information processing apparatus, such as a PC, a server computer, or a tablet terminal, and the basic configuration is substantially the same.

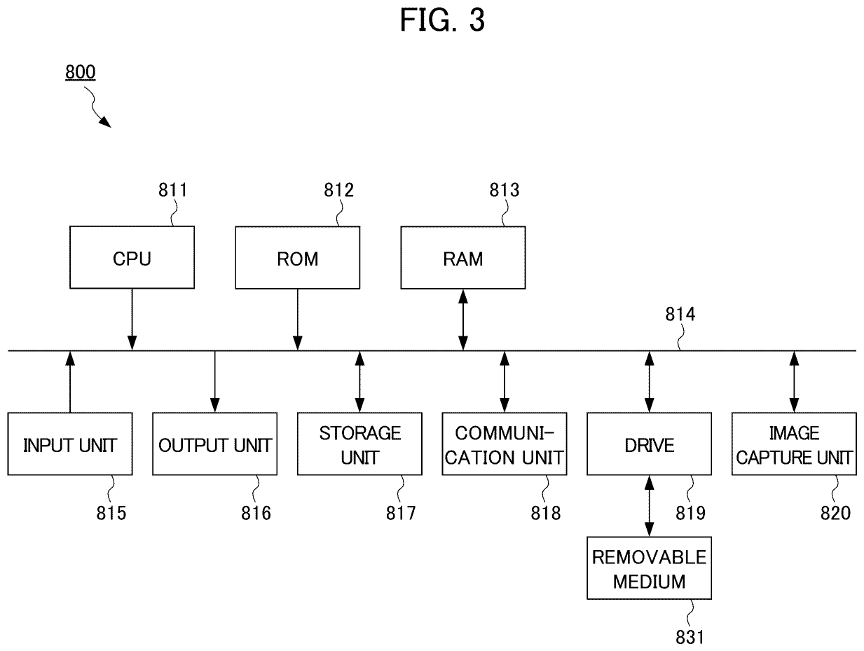

FIG. 3 is a diagram illustrating the hardware configuration of an information processing apparatus 800 configuring each apparatus.

As illustrated in FIG. 3, the information processing apparatus 800 configuring each apparatus includes a CPU (Central Processing Unit) 811, a ROM (Read Only Memory) 812, a RAM (Random Access Memory) 813, a bus 814, an input unit 815, an output unit 816, a storage unit 817, a communication unit 818, a drive 819, and an image capture unit 820.

The CPU 811 executes various processing according to programs that are recorded in the ROM 812, or programs that are loaded from the storage unit 820 to the RAM 813.

The RAM 813 also stores data and the like necessary for the CPU 811 to execute the various processing, as appropriate.

The CPU 811, the ROM 812 and the RAM 813 are connected to one another via the bus 814. The input unit 815, the output unit 816, the storage unit 817, the communication unit 818, the drive 819 and the image capture unit 820 are connected to the bus 814.

The input unit 815 is configured by various buttons and the like, and inputs a variety of information in accordance with instruction operations by the user.

The output unit 816 is configured by the display unit, a speaker, and the like, and outputs images and sound.

The storage unit 817 is configured by DRAM (Dynamic Random Access Memory) or the like, and stores various data managed by each server.

The communication unit 818 controls communication with other devices via networks.

A removable medium 831 composed of a magnetic disk, an optical disk, a magneto-optical disk, semiconductor memory or the like is installed in the drive 819, as appropriate. Programs that are read via the drive 819 from the removable medium 831 are installed in the storage unit 817, as necessary.

The image capture unit 820, which is configured by using an imaging apparatus including a lens and an image sensor, captures digital images of subjects.

When the information processing apparatus 800 is configured as the service providing server 50 or the component providing server 60, the image capture unit 820 may be omitted. When the information processing apparatus 800 is configured by using a tablet terminal, the input unit 815 may be configured by using a touch sensor which overlies the display of the output unit 816. Thus, the information processing apparatus 800 may have a configuration including a touch panel.

### [Functional Configuration]

The functional configuration of each apparatus in the information processing system 1 will be described.

### [Configuration of the Service Development Terminal 10]

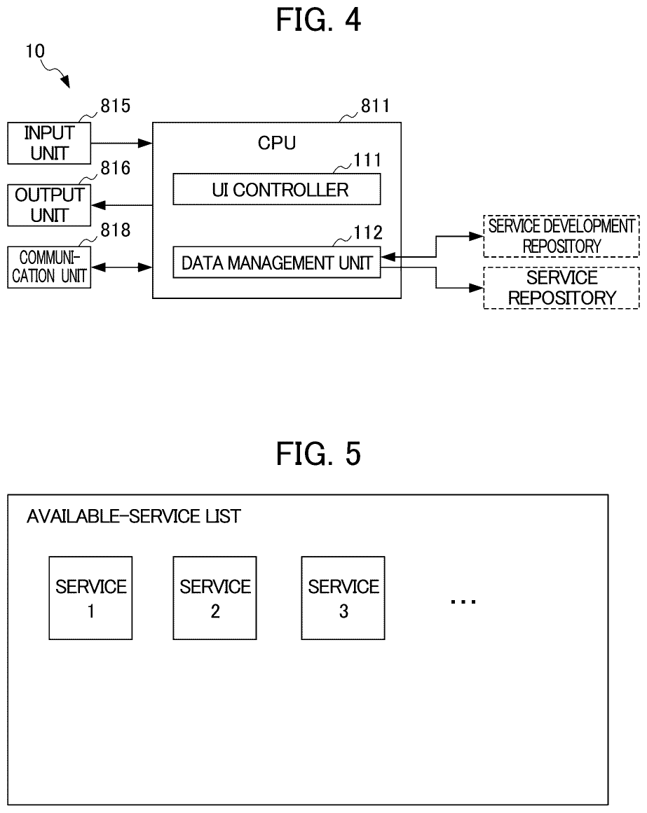

FIG. 4 is a block diagram illustrating the functional configuration of the service development terminal 10.

As illustrated in FIG. 4, the CPU 811 of the service development terminal 10 functions as a UI controller 111 and a data management unit 112.

The UI controller 111 controls display of various types of input/output screens (hereinafter referred to as “UI screens”) used when a developer develops programs for providing services corresponding to widgets. For example, the UI controller 111 displays, on a UI screen, a list of programs for providing services, which are stored in the service repository 522 of the service providing server 50.

The data management unit 112 obtains a list of programs for providing services, which are stored in the service repository 522 of the service providing server 50, and outputs the obtained list to the UI controller 111.

In addition, the data management unit 112 transmits, to the service providing server 50, a program (a program for providing a service corresponding to a widget), which is being developed by a developer on a UI screen, every predetermined time (for example, every minute). The program, which has been transmitted to the service providing server 50 and which is being created, is stored in the service development repository 521. When the development of the program for providing a service corresponding to a widget is completed, the data management unit 112 transmits, to the service providing server 50, the developed program as a program for release (a program for providing a service corresponding to a widget). The program for release, which has been transmitted to the service providing server 50, is stored in the service repository 522.

FIG. 5 is a schematic diagram illustrating an exemplary UI screen displaying a list of programs for providing services, which are stored in the service repository 522.

As illustrated in FIG. 5, a UI screen on the service development terminal 10 displays a list of programs for providing services, which are stored in the service repository 522. A developer may select, from the list, a program for providing a necessary service, and may reuse the selected program.

Therefore, when the already developed service programs include a program which may be reused in the development being performed this time, a developer, who develops a program for providing a service, does not develop a new program for providing the service, and may obtain a necessary program quickly.

### [Configuration of the Widget Development Terminal 20]

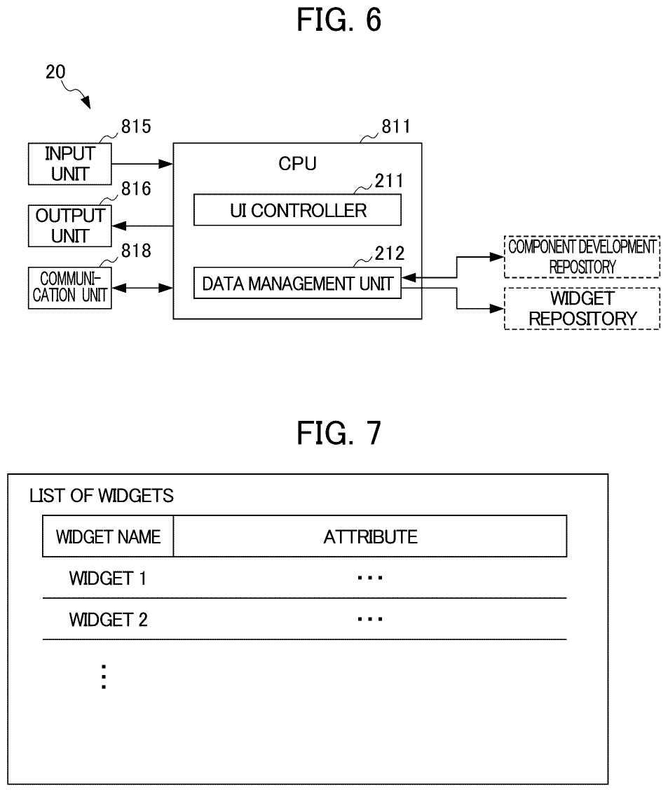

FIG. 6 is a block diagram illustrating the functional configuration of the widget development terminal 20.

As illustrated in FIG. 6, the CPU 811 of the widget development terminal 20 functions as a UI controller 211 and a data management unit 212.

The UI controller 211 controls display of various types of input/output screens (UI screens) used when a developer develops widgets. For example, the UI controller 211 displays, on a UI screen, a list of widgets stored in the widget repository 621 of the component providing server 60.

The data management unit 212 obtains a list of widgets stored in the widget repository 621 of the component providing server 60, and outputs the obtained list to the UI controller 211.

The data management unit 212 transmits, to the component providing server 60, a widget, which is being developed by a developer on a UI screen, every predetermined time (for example, every minute). The widget, which is being created and which has been transmitted to the component providing server 60, is stored in the component development repository 624. When development of the widget is completed, the data management unit 212 transmits, to the component providing server 60, the developed widget as a widget for release. The widget for release, which has been transmitted to the component providing server 60, is stored in the widget repository 621.

FIG. 7 is a schematic diagram illustrating an exemplary UI screen displaying a list of widgets stored in the widget repository 621.

As illustrated in FIG. 7, a UI screen on the widget development terminal 20 displays a list of widgets (widget names and attributes) stored in the widget repository 621. A developer may select, from the list, a necessary widget for reuse.

Therefore, when the already developed widgets include a widget which may be reused in the development being performed this time, a developer, who develops a widget, does not develop a new widget, and may obtain a necessary widget quickly.

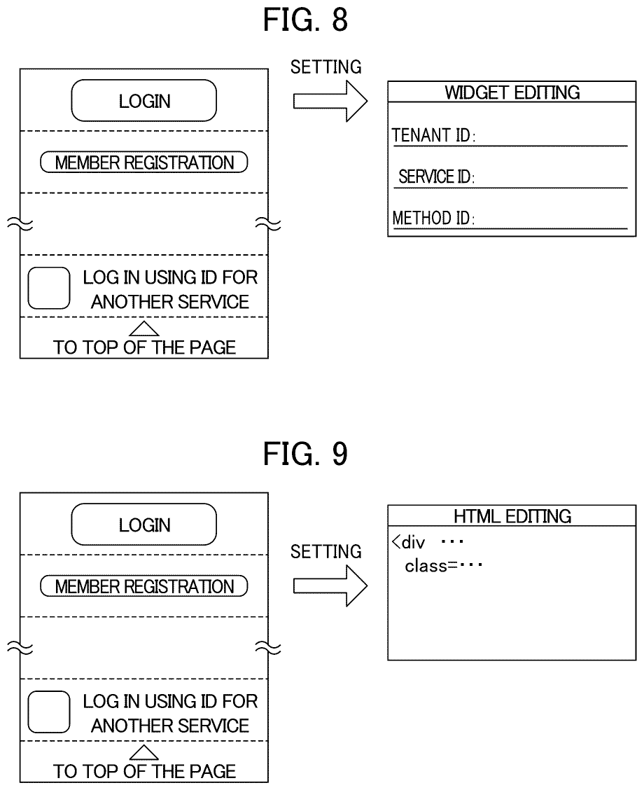

FIG. 8 is a schematic diagram illustrating the relationship between a widget and a service corresponding to the widget.

FIG. 9 is a schematic diagram illustrating data for defining a widget.

As illustrated in FIG. 8, in the information processing system 1, services are prepared in association with the respective widgets. The widgets may be used by appropriately changing the parameters (such as the names of variables for storing input numeric values, and shop names linked to widgets) which are set to the widgets.

As illustrated in FIG. 9, the content of a widget is defined by using a predetermined format such as a structured document. In development of a widget, a new definition may be created in the predetermined format, or the definition of an existing widget may be changed.

### [Configuration of the Operator/Administrator Terminal 30]

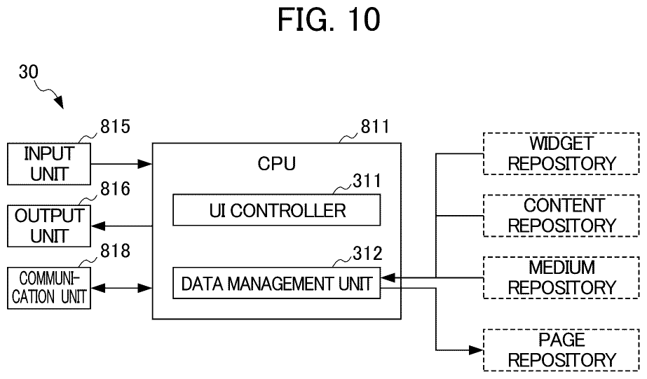

FIG. 10 is a block diagram illustrating the functional configuration of the operator/administrator terminal 30.

As illustrated in FIG. 10, the CPU 811 of the operator/administrator terminal 30 functions as a UI controller 311 and a data management unit 312.

The UI controller 311 controls display of various types of input/output screens (UI screens) used when an operator or an administrator creates pages for providing services. For example, the UI controller 311 displays, on a UI screen, a list of widgets, content, and media which are stored in the widget repository 621, the content repository 622, and the medium repository 623 of the component providing server 60.

The data management unit 312 obtains a list of widgets, content, and media which are stored in the widget repository 621, the content repository 622, and the medium repository 623 of the component providing server 60, and outputs the obtained list to the UI controller 311.

In response to an instruction from an operator or an administrator, the data management unit 312 transmits, to the component providing server 60, data of a page that is being created by the operator or the administrator on a UI screen. Data of a page, which is being created and which has been transmitted to the component providing server 60, is stored in the page repository 625 temporarily. The data management unit 312 may transmit, to the service providing server 50, data of a page, which is being created by an operator or an administrator on a UI screen, every predetermined time (for example, every minute). When creation of a page is completed, the data management unit 312 transmits, to the component providing server 60, data of the created page as page data for release. The page data for release, which has been transmitted to the component providing server 60, is stored in the page repository 625. When creation of a page is completed, the data management unit 312 may transmit, also to the service providing server 50, data of the created page as page data for release. Page data for release, which has been transmitted to the service providing server 50, is stored in the service repository 522.

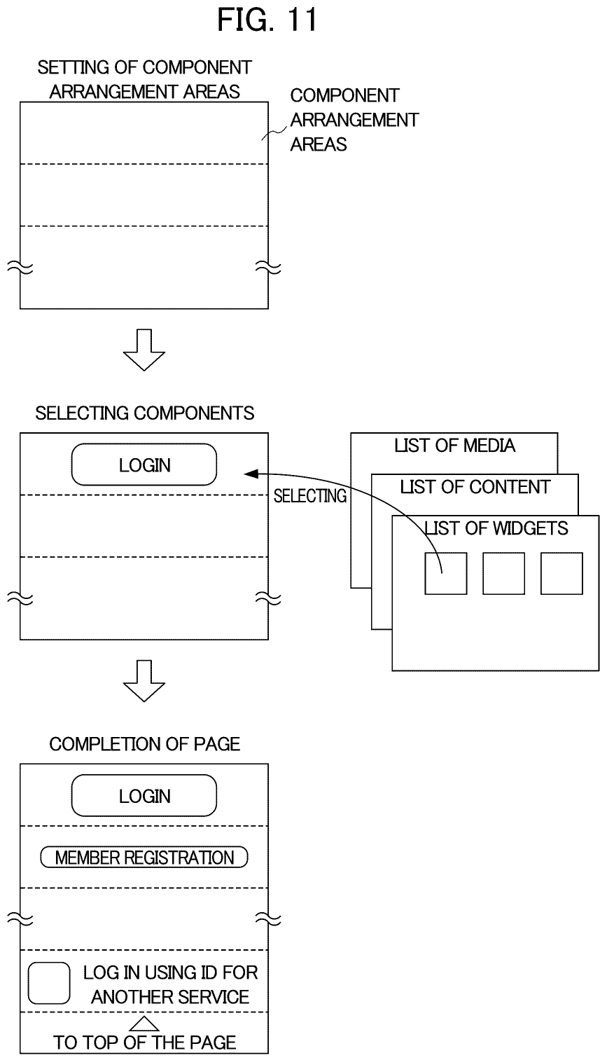

FIG. 11 is a schematic diagram illustrating an exemplary UI screen for indicating a process of creation of a page.

As illustrated in FIG. 11, in creation of a page, component arrangement areas for disposing components (screen components) are set in the page area. A necessary element, which is selected from a list of elements (in this case, widgets) displayed on a UI screen, is disposed in a corresponding component position area. As a result of this process, a page for providing a service, which an operator or an administrator aims to provide, is completed.

### [Configuration of the End-User Terminal 40]

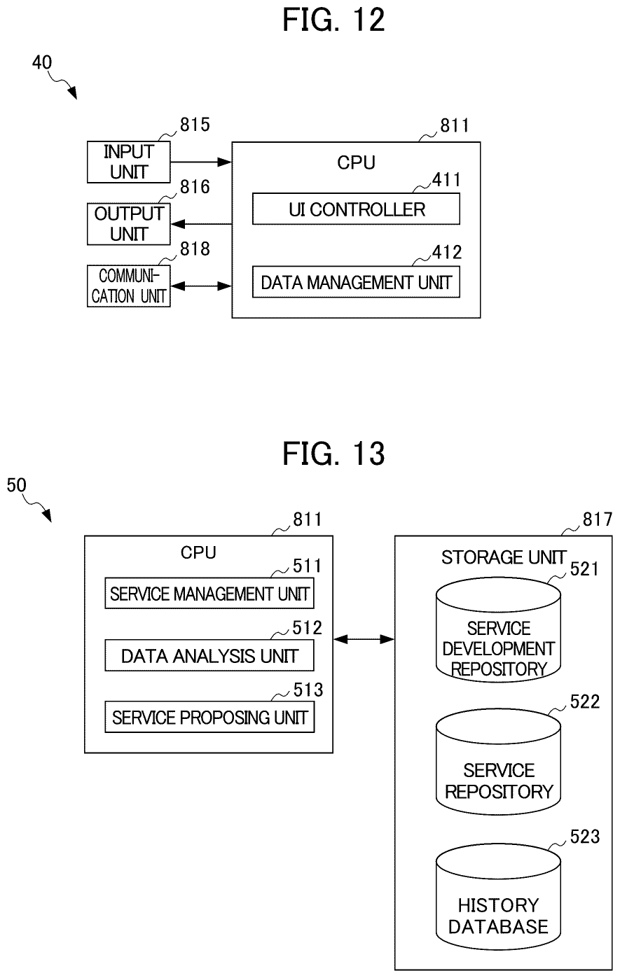

FIG. 12 is a block diagram illustrating the functional configuration of the end-user terminal 40.

As illustrated in FIG. 12, the CPU 811 of the end-user terminal 40 functions as a UI controller 411 and a data management unit 412. In the present embodiment, the functions of the UI controller 411 and the data management unit 412 of the end-user terminal 40 are implemented in a Web browser.

The UI controller 411 controls display of various types of input/output screens (UI screens) used when an end user uses a service (for example, a business service such as mail-order selling) provided by the information processing system 1. For example, the UI controller 411 displays, on a UI screen, a list of pages stored in the service repository 522 of the service providing server 50.

The data management unit 412 obtains a list of pages stored in the service repository 522 of the service providing server 50, and outputs the obtained list to the UI controller 411.

When an end user selects a target page, the data management unit 412 requests data of the selected page, and thus receives data of the page from the service providing server 50. The data management unit 412 outputs the received page data to the UI controller 411 for display, and, in response to the end user's operation, executes a widget included in the received page data. The data management unit 412 transmits, to the service providing server 50, a request for execution of the service corresponding to the widget, as an API. Then, the data management unit 412 obtains the execution result, which has been transmitted from the service providing server 50, of the service corresponding to the widget, and outputs the result to the UI controller 411 for display of the execution result at the predetermined position (the position defined in the widget) of the page.

### [Configuration of the Service Providing Server 50]

FIG. 13 is a block diagram illustrating the functional configuration of the service providing server 50.

As illustrated in FIG. 13, the CPU 811 of the service providing server 50 functions as a service management unit 511, a data analysis unit 512, and a service proposing unit 513. The service development repository 521, the service repository 522, and the history database (history DB) 523 are formed in the storage unit 817 of the service providing server 50. The service development repository 521 stores programs for providing services, which are being developed on the service development terminal 10, sequentially.

The service repository 522 stores released programs for providing services. The service repository 522 also stores data of pages (released pages) for providing services, which are created on the operator/administrator terminal 30. In the present embodiment, various types of programs (existing and newly-developed programs) for implementing services provided by the information processing system 1 are centrally stored in the service repository 522. When, for example, a new business logic is to be developed, the service flow may be designed by appropriately combining services, which are stored in the service repository 522.

The history DB 523 stores history data obtained through provision of services.

The service management unit 511 transmits, to the service development terminal 10 where programs for services are developed, a list of programs for providing services, which are stored in the service repository 522.

The service management unit 511 obtains a program for a service, which is being developed on the service development terminal 10, every predetermined time (for example, every minute), and stores the obtained program in the service development repository 521.

The service management unit 511 obtains programs for services, which are completed on the service development terminal 10, and stores the obtained programs in the service repository 522. The service management unit 511 stores, in the service repository 522, completed programs for services, and the completed programs are thus released. The service management unit 511 also stores, in the service repository 522, data of pages (released pages) for providing services, which are completed on the operator/administrator terminal 30. The service management unit 511 transmits, to the end-user terminal 40 which uses services provided by the information processing system 1, a list of page data stored in the service repository 522. In response to a request for page data from the end-user terminal 40, the service management unit 511 transmits the page data to the end-user terminal 40 from which the request has been transmitted.

In response to a request for use of a service as an API, the service management unit 511 executes the program for the service, and transmits the execution result data to the request source. In provision of a service, the service management unit 511 obtains various types of history data, and stores the various types of obtained history data in the history DB 523.

The data analysis unit 512 analyzes the trend and characteristics of history data stored in the history DB 523. For example, the data analysis unit 512 obtains, through analysis, the trend in which the access counts of pages, in which a specific service is embedded, dramatically increase, or obtains, through analysis, the fact that the attributes of users, who access pages in which a specific service is embedded, are significantly biased.

The service proposing unit 513 generates new application examples of services obtained through utilization of the trend and characteristics analyzed by the data analysis unit 512. For example, when the data analysis unit 512 determines that a service used in a specific field is expandable to a different field, the data analysis unit 512 regards a service, which is obtained by expanding the field of the service, as a new application example. When the data analysis unit 512 determines that a combination of a service used in a specific field and a service used in a different field produces a synergistic effect, the data analysis unit 512 regards a service, which is obtained through combination of the services, as a new application example.

The service proposing unit 513 proposes the new service application examples, which are generated, to a developer using the service development terminal 10 or a developer using the widget development terminal 20.

### [Configuration of the Component Providing Server 60]

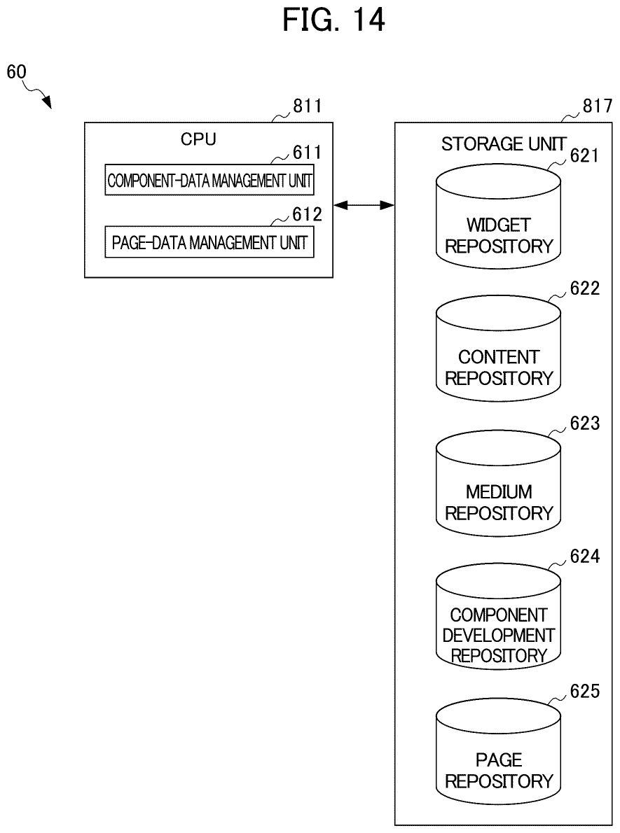

FIG. 14 is a block diagram illustrating the functional configuration of the component providing server 60.

As illustrated in FIG. 14, the CPU 811 of the component providing server 60 functions as a component-data management unit 611 and a page-data management unit 612. The widget repository 621, the content repository 622, the medium repository 623, the component development repository 624, and the page repository 625 are formed in the storage unit 817 of the component providing server 60.

The widget repository 621 stores various types of released widgets.

The content repository 622 stores data of various types of content (in this example, HTML files whose description is fixed) which may be embedded in pages for providing services.

The medium repository 623 stores data of various types of media (in this example, still image data, movie data, music data or banner data) which may be embedded in pages for providing services.

The component development repository 624 stores data (such as files for defining widgets) of components (widgets) that are being developed on the widget development terminal 20.

The page repository 625 stores data of released pages for providing services.

The component-data management unit 611 transmits, to the widget development terminal 20 where widgets are developed, a list of widgets stored in the widget repository 621.

The component-data management unit 611 obtains a widget, which is being developed on the widget development terminal 20, every predetermined time (for example, every minute), and stores the obtained widget in the component development repository 624.

The component-data management unit 611 stores, in the widget repository 621, widgets that are completed on the widget development terminal 20, and the completed widgets are thus released.

The page-data management unit 612 transmits a list of widgets, content, and media, which are stored in the widget repository 621, the content repository 622, and the medium repository 623, to the operator/administrator terminal 30 where pages are created.

The page-data management unit 612 obtains data of pages completed on the operator/administrator terminal 30, and stores the obtained page data in the page repository 625. The page-data management unit 612 stores data of completed pages in the page repository 625, and the completed pages are thus released. In response to transmission of data of a page, which is being created on the operator/administrator terminal 30, through an instruction from an operator or an administrator, the page-data management unit 612 obtains data of the page, which is being created, and temporarily stores, in the page repository 625, the obtained page data as data of a page being created. The page-data management unit 612 may obtain data of a page, which is being created on the operator/administrator terminal 30, every predetermined time (for example, every minute), and may temporarily store, in the page repository 625, the obtained page data as data of a page being created. The data of temporarily stored pages, which are being created, is not included in a list of reusable components transmitted to the operator/administrator terminal 30.

The page-data management unit 612 transmits, to the service providing server 50, page data (released data) stored in the page repository 625. The page-data management unit 612 may transmit a list of pages, which are stored in the page repository 625, to the end-user terminal 40 using services provided by the information processing system 1. In this case, in response to a request for page data from the end-user terminal 40, the page-data management unit 612 transmits data of the page to the end-user terminal 40 from which the request has been transmitted.

### [Operation]

The operation of the information processing system 1 will be described.

### [Service Development Process]

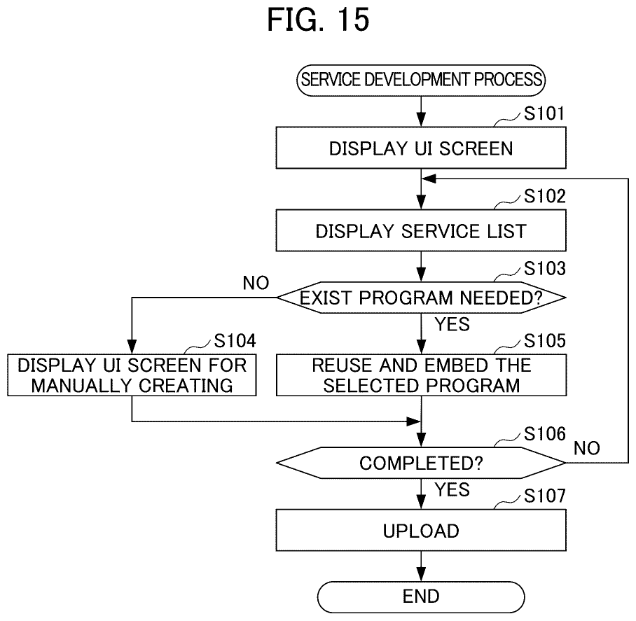

FIG. 15 is a flowchart of a service development process performed by the service development terminal 10.

The service development process starts in response to input, through the input unit 815 of the service development terminal 10, of an instruction to execute the service development process.

When the service development process starts, in step S101, the UI controller 111 displays a UI screen used when a developer develops a program for providing a service corresponding to a widget.

In step S102, the data management unit 112 obtains a list (service list) of programs for providing services, which are stored in the service repository 522 of the service providing server 50. The UI controller 111 displays, on a UI screen, the obtained list of programs for providing services.

In step S103, the UI controller 111 determines whether the displayed list of existing programs includes a program needed by the developer (that is, whether the developer has selected an existing program).

If the displayed list of existing programs does not include a program for a service needed by the developer (the developer has not selected an existing program), it is determined that the determination result is NO in step S103, and the process proceeds to step S104.

If the displayed list of existing programs includes a program for a service needed by the developer (the developer has selected an existing program), it is determined that the determination result is YES in step S103, and the process proceeds to step S105.

In step S104, the UI controller 111 displays a UI screen for manually creating a service program.

After step S104, the process proceeds to step S106. In step S105, the UI controller 111 reuses the selected existing program and embeds the selected program in the service program which is being developed.

In step S106, the UI controller 111 determines whether the developer has performed an operation indicating completion of the service program (such as an operation on the “Completed” button).

If the developer has not performed an operation indicating completion of the service program, it is determined that the determination result is NO in step S106, and the process proceeds to step S102.

If the developer has performed an operation indicating completion of the service program, it is determined that the determination result is YES in step S106, and the process proceeds to step S107.

In step S107, the data management unit 112 transmits (uploads), for release, the completed service program to the service providing server 50.

After step S107, the service development process ends.

### [Widget Development Process]

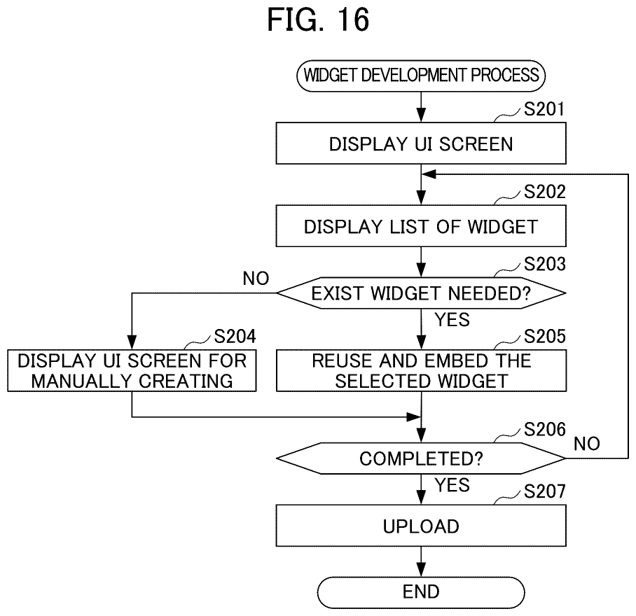

FIG. 16 is a flowchart of a widget development process performed by the widget development terminal 20.

The widget development process starts in response to input, through the input unit 815 of the widget development terminal 20, of an instruction to perform the widget development process.

When the widget development process starts, in step S201, the UI controller 211 displays an UI screen used when a developer develops a widget.

In step S202, the data management unit 212 obtains a list of widgets stored in the widget repository 621 of the component providing server 60. The UI controller 211 displays the obtained list of widgets on the UI screen.

In step S203, the UI controller 211 determines whether the displayed list of existing widgets includes a widget needed by the developer (that is, whether the developer has selected an existing widget).

If the displayed list of existing widgets does not include a widget needed by the developer (the developer has not selected an existing widget), it is determined that the determination result is NO in step S203, and the process proceeds to step S204.

If the displayed list of existing widgets includes a widget needed by the developer, (the developer has selected an existing widget), it is determined that the determination result is YES in step S203, and the process proceeds to step S205.

In step S204, the UI controller 211 displays a UI screen for manually creating a widget.

After step S204, the process proceeds to step S206. In step S205, the UI controller 211 reuses the selected existing widget, and embeds the selected widget in the widget which is being developed.

In step S206, the UI controller 211 determines whether the developer has performed an operation indicating completion of the widget (such as an operation on the “Completed” button).

If the developer has not performed an operation indicating completion of the widget, it is determined that the determination result is NO in step S206, and the process proceeds to step S202.

If the developer has performed an operation indicating completion of the widget, it is determined that the determination result is YES in step S206, and the process proceeds to step S207.

In step S207, the data management unit 212 transmits (uploads), for release, the completed widget to the component providing server 60.

After step S207, the widget development process ends.

### [Page Edit Process]

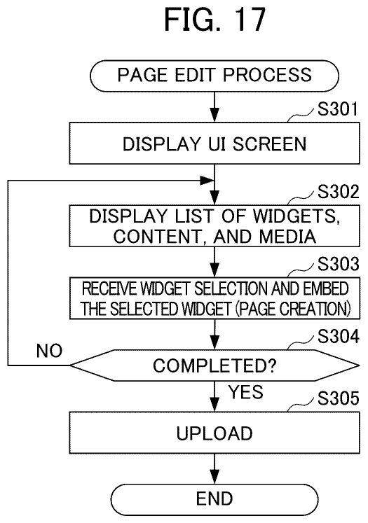

FIG. 17 is a flowchart of a page edit process performed by the operator/administrator terminal 30. The page edit process starts in response to input, through the input unit 815 of the operator/administrator terminal 30, of an instruction to perform the page edit process.

When the page edit process starts, in step S301, the UI controller 311 displays a UI screen used when an operator or an administrator creates a page for providing a service.

In step S302, the data management unit 312 obtains a list of widgets, content, and media which are stored in the widget repository 621, the content repository 622, and the medium repository 623 of the component providing server 60. The UI controller 311 displays the obtained list of widgets, content, and media on the UI screen. The data management unit 312 may obtain a list of released page data stored in the page repository 625 of the component providing server 60, and the UI controller 311 may display the obtained list in combination with widgets, content, and media on the UI screen.

In step S303, the UI controller 311 receives selection from the widgets, content, and media (the screen components) which is performed by the creator of the page, and embeds the selected widget, content, or medium in the page.

In step S304, the UI controller 311 determines whether the page creator has performed an operation indicating completion of the page (such as an operation on the “Completed” button).

If the page creator has not performed an operation indicating completion of the page, it is determined that the determination result is NO in step S304, and the process proceeds to step S302.

If the page creator has performed an operation indicating completion of the page, it is determined that the determination result is YES in step S304, and the process proceeds to step S305.

In step S305, the data management unit 312 transmits (uploads), for release, the completed page to the component providing server 60.

After step S305, the page edit process ends.

### [Service Use Process]

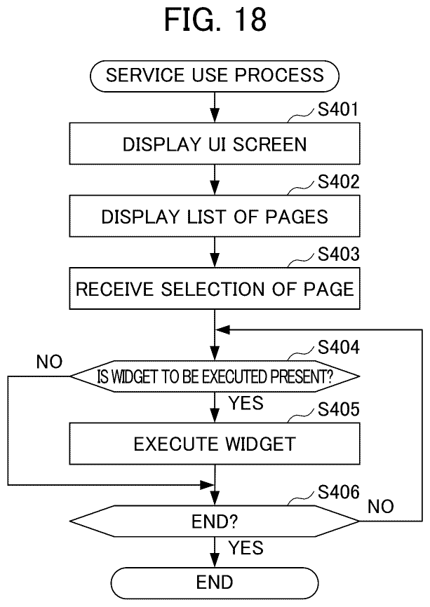

FIG. 18 is a flowchart of a service use process performed by the end-user terminal 40.

The service use process starts in response to input, through the input unit 815 of the end-user terminal 40, of an instruction to perform the service use process.

When the service use process starts, in step S401, the UI controller 411 displays a UI screen used when an end user uses a service provided by the information processing system 1.

In step S402, the data management unit 412 obtains a list of pages stored in the service repository 522 of the service providing server 50. The UI controller 411 displays the obtained list of pages on the UI screen.

In step S403, the UI controller 411 receives the end user's selection of a page. The UI controller 411 draws the selected page.

In step S404, the data management unit 412 determines whether a widget to be executed is present (whether an instruction to execute a widget has been submitted).

If no widgets to be executed are present, it is determined that the determination result is NO in step S404, and the process proceeds to step S406.

If a widget to be executed is present, it is determined that the determination result is YES in step S404, and the process proceeds to step S405.

In step S405, the data management unit 412 executes the widget, and transmits, to the service providing server 50, a request for execution of the service corresponding to the widget, as an API.

In step S406, the UI controller 411 determines whether an operation for ending the service use process (such as an operation on the “End” button) has been performed.

If an operation for ending the service use process has not been performed, it is determined that the determination result is NO in step S406, and the process proceeds to step S404.

If an operation for ending the service use process has performed, it is determined that the determination result is YES in step S406, and the service use process ends.

### [Component Creation Receiving Process]

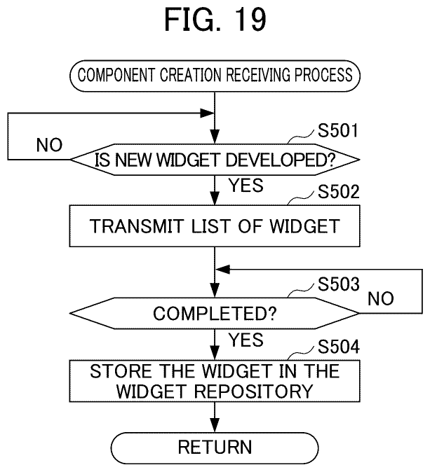

FIG. 19 is a flowchart of a component creation receiving process performed by the component providing server 60.

The component creation receiving process starts with a startup of the component providing server 60, and is performed repeatedly.

When the component creation receiving process starts, in step S501, the component-data management unit 611 determines whether a new widget is being developed on the widget development terminal 20.

If a new widget is not being developed on the widget development terminal 20, it is determined that the determination result is NO in step S501, and step S501 is repeatedly performed.

If a new widget is being developed on the widget development terminal 20, it is determined that the determination result is YES in step S501, and the process proceeds to step S502.

In step S502, the component-data management unit 611 transmits a list of widgets, which are stored in the widget repository 621, to the widget development terminal 20 where the new widget is being developed. In step S503, the component-data management unit 611 determines whether development of the new widget has been completed.

If development of the new widget has not been completed, it is determined that the determination result is NO in step S503, and step S503 is repeatedly performed. If development of the new widget has not been completed, the component-data management unit 611 obtains the widget, which is being developed on the widget development terminal 20, every predetermined time (for example, every minute), and stores the obtained widget in the component development repository 624.

If development of the new widget has been completed, it is determined that the determination result is YES in step S503, and the process proceeds to step S504.

In step S504, the component-data management unit 611 stores the widget, which has been completed on the widget development terminal 20, in the widget repository 621. Thus, the completed widget is released.

After step S504, the component creation receiving process is repeatedly performed.

### [Page Creation Receiving Process]

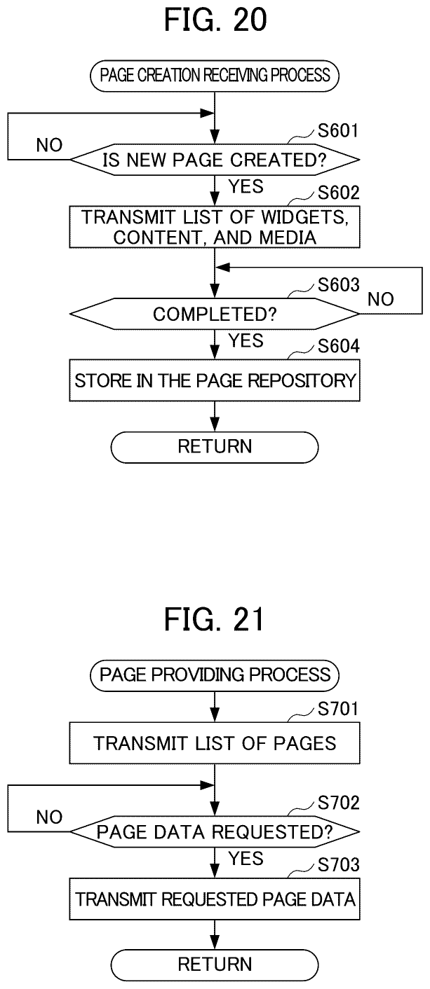

FIG. 20 is a flowchart of a page creation receiving process performed by the component providing server 60.

The page creation receiving process starts with a startup of the component providing server 60, and is repeatedly performed.

When the page creation receiving process starts, in step S601, the page-data management unit 612 determines whether a new page is being created on the operator/administrator terminal 30.

If a new page is not being created on the operator/administrator terminal 30, it is determined that the determination result is NO in step S601, and step S601 is repeatedly performed.

If a new page is being created on the operator/administrator terminal 30, it is determined that the determination result is YES in step S601, and the process proceeds to step S602.

In step S602, the page-data management unit 612 transmits a list of widgets, content, and media, which are stored in the widget repository 621, the content repository 622, and the medium repository 623, to the operator/administrator terminal 30 where the new page is being created. At that time, the page-data management unit 612 may transmit a list of released page data stored in the page repository 625. In step S603, the page-data management unit 612 determines whether creation of the new page has been completed.

If creation of the new page has not been completed, it is determined that the determination result is NO in step S603, and step S603 is repeatedly performed. If creation of the new page has not been completed, in response to transmission of data of the page, which is being created on the operator/administrator terminal 30, through an instruction from the operator or the administrator, the page-data management unit 612 obtains data of the page, which is being created, and temporarily stores the obtained page data as data of a page, which is being created, in the page repository 625. The page-data management unit 612 may obtain data of the page, which is being developed on the operator/administrator terminal 30, every predetermined time (for example, every minute), and may temporarily store the obtained page data as data of a page, which is being created, in the page repository 625. The temporarily stored page data is not included in a list of reusable components which is transmitted to the operator/administrator terminal 30.

If creation of the new page has been completed, it is determined that the determination result is YES in step S603, and the process proceeds to step S604.

In step S604, the page-data management unit 612 stores, in the page repository 625, data of the page completed on the operator/administrator terminal 30. Thus, the completed page is released.

After step S604, the page creation receiving process is repeatedly performed.

### [Page Providing Process]

FIG. 21 is a flowchart of a page providing process performed by the service providing server 50.

The page providing process starts with a startup of the service providing server 50, and is repeatedly performed.

When the page providing process starts, in step S701, the service management unit 511 transmits a list of pages stored in the service repository 522, to the end-user terminal 40 using a service provided by the information processing system 1.

In step S702, the service management unit 511 determines whether the end-user terminal 40 has transmitted a request for page data.

If the end-user terminal 40 has not transmitted a request for page data, it is determined that the determination result is NO in step S702, and step S702 is repeatedly performed.

If the end-user terminal 40 has transmitted a request for page data, it is determined that the determination result is YES in step S702, and the process proceeds to step S703.

In step S703, the service management unit 511 transmits the requested page data to the end-user terminal 40 which has been transmitted the request.

After step S703, the page providing process is repeatedly performed.

### [Service Creation Receiving Process]

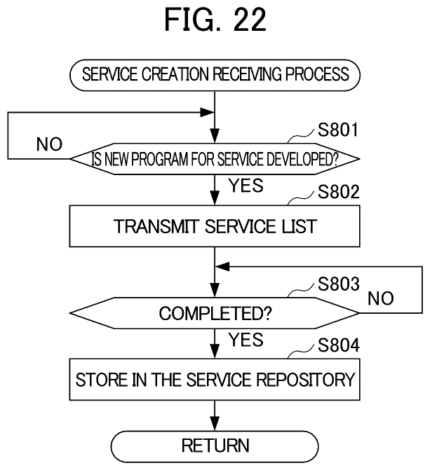

FIG. 22 is a flowchart of a service creation receiving process performed by the service providing server 50.

The service creation receiving process starts with a startup of the service providing server 50, and is repeatedly performed.

When the service creation receiving process starts, in step S801, the service management unit 511 determines whether a new program for a service is being developed on the service development terminal 10.

If a new program for a service is not being developed on the service development terminal 10, it is determined that the determination result is NO in step S801, step S801 is repeatedly performed.

If a new program for a service is being developed on the service development terminal 10, it is determined that the determination result is YES in step S801, and the process proceeds to step S802.

In step S802, the service management unit 511 transmits a list (service list) of programs for providing services, which are stored in the service repository 522, to the service development terminal 10 where the new program for a service is being developed.

In step S803, the service management unit 511 determines whether development of the new service has been completed.

If development of the new service has not been completed, it is determined that the determination result is NO in step S803, and step S803 is repeatedly performed. If development of the new service has not been completed, the service management unit 511 obtains the program for the service, which is being developed on the service development terminal 10, every predetermined time (for example, every minute), and stores the obtained program for the service in the service development repository 521.

If development of the new service has been completed, it is determined that the determination result is YES in step S803, and the process proceeds to step S804.

In step S804, the service management unit 511 stores, in the service repository 522, the program for the service which has been completed on the service development terminal 10. Thus, the completed program for the service is released.

After step S804, the page creation receiving process is repeatedly performed.

### [Service Receiving Process]

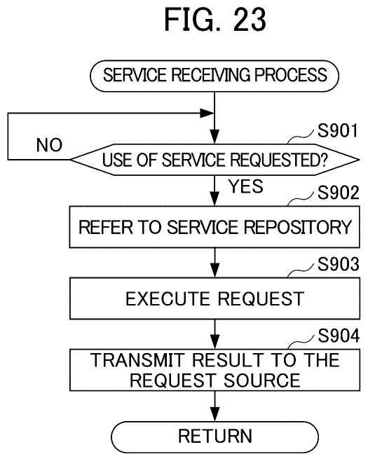

FIG. 23 is a flowchart of a service receiving process performed by the service providing server 50.

The service receiving process starts with a startup of the service providing server 50, and is repeatedly performed.

When the service receiving process starts, in step S901, the service management unit 511 determines whether use of a service has been requested as an API.

If use of a service has not been requested as an API, it is determined that the determination result is NO in step S901, and step S901 is repeatedly performed. If use of a service has been requested as an API, it is determined that the determination result is YES in step S901, and the process proceeds to step S902. In step S902, the service management unit 511 refers to the service repository 522. At that time, the service management unit 511 obtains information about the requested service (for example, information about access to a server on a cloud system which provides the service).

In step S903, the service management unit 511 executes the request on the basis of the information about the requested service. For example, the service management unit 511 accesses the server on the cloud system which provides the requested service, and thus obtains the execution result of the request.

In step S904, the service management unit 511 transmits the execution result of the request to the request source.

After step S904, the service receiving process is repeatedly performed.

### [Data Analysis Process]

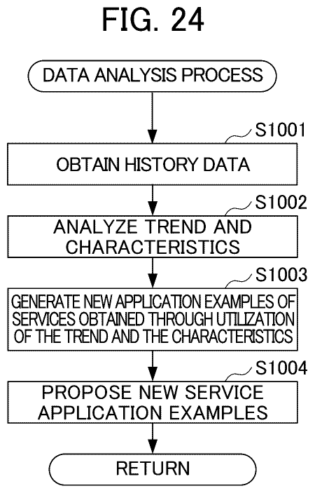

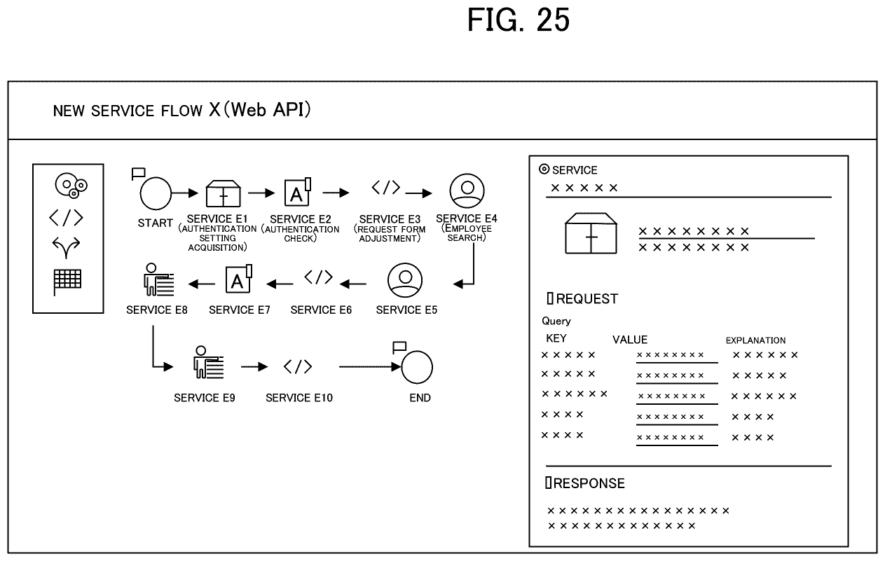

FIG. 24 is a flowchart of a data analysis process performed by the service providing server 50.

The data analysis process starts in response to input, through the input unit 815 of the service providing server 50, of an instruction to perform the data analysis process, or a request, from a terminal apparatus (such as the operator/administrator terminal 30), to perform the data analysis process.

When the data analysis process starts, in step S1001, the data analysis unit 512 obtains history data stored in the history DB 523.

In step S1002, the data analysis unit 512 analyzes the trend and characteristics of the history data. For example, the data analysis unit 512 obtains, through analysis, the trend in which the access counts of pages, in which a specific service is embedded, dramatically increase, or obtains, through analysis, the fact that the attributes of users, who access pages in which a specific service is embedded, are significantly biased.

In step S1003, the service proposing unit 513 generates new application examples of services obtained through utilization of the trend and the characteristics analyzed by the data analysis unit 512. For example, when the data analysis unit 512 determines that a service used in a specific field is expandable to a different field, the data analysis unit 512 regards a service, which is obtained by expanding the field of the service, as a new application example. When the data analysis unit 512 determines that a combination of a service used in a specific field and a service used in a different field produces a synergistic effect, the data analysis unit 512 regards a service, which is obtained through combination of the services, as a new application example.

In step S1004, the service proposing unit 513 proposes the new service application examples, which are generated, to a developer using the service development terminal 10 or a developer using the widget development terminal 20.

After step S1004, the data analysis process ends.

As described above, the information processing system 1 according to the present embodiment cooperates with multiple types of cloud systems, and provides services in the DevOps environment. The information processing system 1 accumulates, for example, widgets serving as elements, which are to be embedded in pages for providing services, and service programs for implementing actions of the widgets. The information processing system 1 enables pages for providing new services to be constructed through reuse of the accumulated widgets and service programs.

Therefore, in construction of pages for providing new services, elements necessary for the services are selected and embedded in the pages, enabling simple and flexible construction of pages for necessary services.

Therefore, functions in an information processing system may be constructed more rapidly and flexibly.

### [Concrete Application Example]

The information processing system 1 according to the embodiment described above enables, for example, business logic of providing a series of services, to be easily implemented as a system and be executed.

A concrete example, in which a service flow is designed by combining multiple components and in which the designed flow is executed, will be described.

FIG. 25 is a schematic diagram illustrating an exemplary user interface for designing a service flow by combining components.

The user interface illustrated in FIG. 25 may be provided as a form of user interface, for example, in which a page for providing services is created on the operator/administrator terminal 30.

As illustrated in FIG. 25, when “new service flow X” (Web API) for implementing a new business logic is to be designed, blocks representing components, which correspond to services and which are provided by the service providing server 50, are combined and arranged. Thus, the logic may be constructed. Components, which correspond to services and which are provided by the service providing server 50, are components representing functions which form a service flow. Thus, such components are called “functional components” appropriately below.

For example, the service flow illustrated in FIG. 25 is constructed by arranging functional components, which represent services E1 to E10 and which are provided by the service providing server 50, as contiguous blocks.

The services E1 to E10 are services serving as elements of the whole, such as an “authentication setting acquisition” service for displaying a user interface for receiving a login, an “authentication check” service for checking whether received authentication information is valid, and a “request form adjustment” service for adjusting a request regarding a system into a predetermined format.

Functional component blocks are arranged in the user interface illustrated in FIG. 25. This causes the programs (programs stored in the service providing server 50) for services corresponding to the arranged functional components to be referred to, and causes the program codes representing the flow of the series of services to be described sequentially. As a result, the program codes, which represent the series of services designed by arranging functional component blocks, are automatically generated.

The service flow designed by using the user interface illustrated in FIG. 25 is stored, for example, in the service repository 522 of the service providing server 50, as page data for providing services.

When an end user selects the page data of “new service flow X”, actual page data (for example, HTML-format page data) for providing the services of “new service flow X” is drawn on the end-user terminal 40.

### [Page-Data Drawing Process]

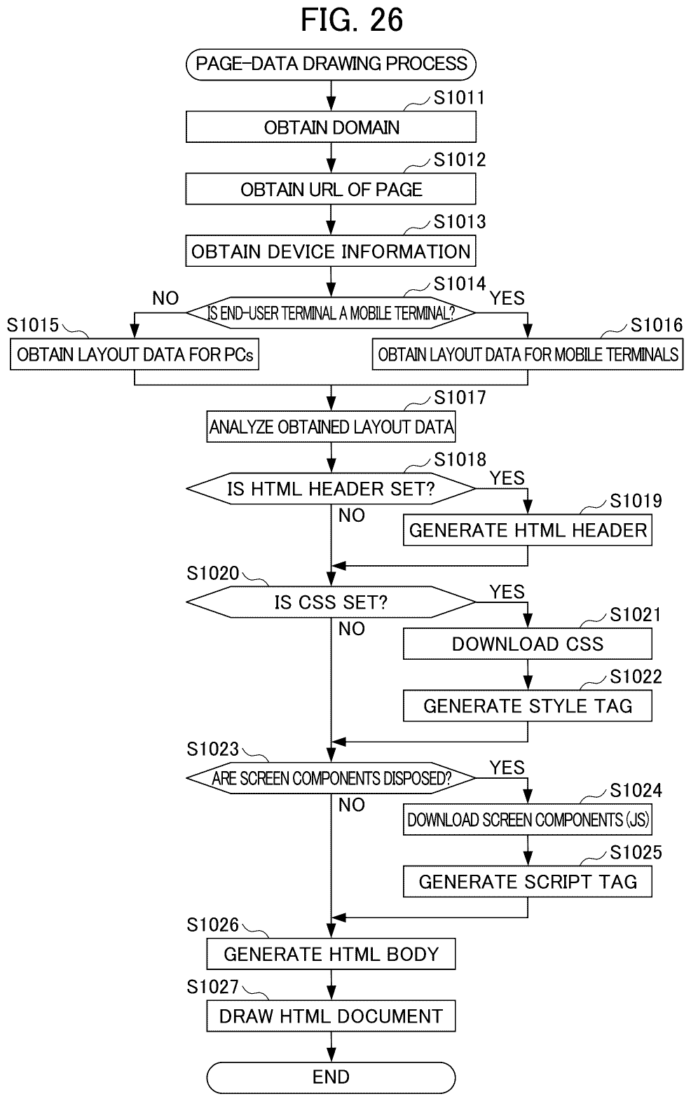

FIG. 26 is a flowchart of a page-data drawing process performed by the end-user terminal 40.

The page-data drawing process is a process of drawing page data for providing a service, and starts in response to selection, on the end-user terminal 40, of a page for providing a service.

When the page-data drawing process starts, in step S1011, the data management unit 412 obtains the domain described in the selected page data.

In step S1012, the data management unit 412 obtains a URL (Uniform Resource Locator) described in the selected page data.

In step S1013, the data management unit 412 obtains device information of the end-user terminal 40.

In step S1014, the data management unit 412 determines whether the end-user terminal 40 is a mobile terminal.

If the end-user terminal 40 is not a mobile terminal, it is determined that the determination result is NO in step S1014, and the process proceeds to step S1015.

If the end-user terminal 40 is a mobile terminal, it is determined that the determination result is YES in step S1014, and the process proceeds to step S1016.

In step S1015, the data management unit 412 obtains layout data for PCs described in the page data.

After step S1015, the process proceeds to step S1017. In step S1016, the data management unit 412 obtains layout data for mobile terminals described in the page data.

In step S1017, the data management unit 412 analyzes the obtained layout data.

In step S1018, the data management unit 412 determines whether an HTML header is set in the obtained layout data.

If an HTML header is set in the obtained layout data, it is determined that the determination result is YES in step S1018, and the process proceeds to step S1019.

If an HTML header is not set in the obtained layout data, it is determined that the determination result is YES in step S1018, and the process proceeds to step S1020.

In step S1019, the data management unit 412 generates an HTML header according to the setting.

In step S1020, the data management unit 412 determines whether CSS (Cascading Style Sheets) are set in the obtained layout data.

If CSS are set in the obtained layout data, it is determined that the determination result is YES in step S1020, and the process proceeds to step S1021.

If CSS are not set in the obtained layout data, it is determined that the determination result is NO in step S1020, and the process proceeds to step S1023.

In step S1021, the data management unit 412 downloads the set CSS from a server which provides the CSS.

In step S1022, the data management unit 412 generates a “style” tag which is added to the layout data.

In step S1023, the data management unit 412 determines whether screen components (JavaScript) are disposed in the page data.

If screen components are disposed in the page data, it is determined that the determination result is YES in step S1023, and the process proceeds to step S1024.

If no screen components are disposed in the page data, it is determined that the determination result is NO in step S1024, and the process proceeds to step S1026.

In step S1024, the data management unit 412 downloads the disposed screen components from servers which provide the screen components.

In step S1025, the data management unit 412 generates a “script” tag which is added to the layout data.

In step S1026, the data management unit 412 generates an HTML body on the basis of the page data.

In the HTML body generated at that time, data for displaying each of the component blocks, which represent the services E1 to E10, in accordance with the progress of the service is described (see FIG. 25).

In step S1027, the UI controller 411 draws the HTML document generated in the processes until step S1026. As a result, a Web page for implementing “new service flow X” is displayed on the end-user terminal 40, and each step of “new service flow X” is performed in accordance with the user's operations.

### [Service Providing Process]

A process (service providing process), which is performed by the service providing server 50 and which implements a designed business flow, will be described.

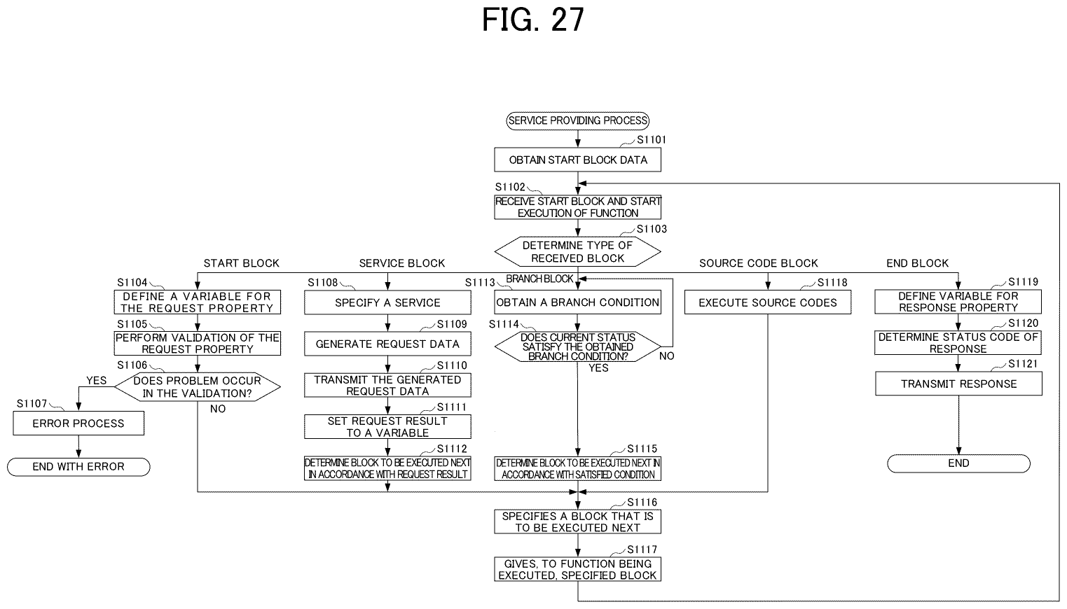

FIG. 27 is a flowchart of the service providing process performed by the service providing server 50.

The service providing process starts in response to the state in which page data for providing a service is drawn on the end-user terminal 40 and execution of a service is selected.

When the service providing process starts, in step S1101, the service management unit 511 obtains start block data of the service whose execution has been selected on the end-user terminal 40.

In step S1102, the service management unit 511 receives the start block of the service as an argument, and starts execution of the function of providing the service.

In step S1103, the service management unit 511 determines the type of the received block. In the present embodiment, “start block”, “service block”, “branch block”, “source code block”, and “end block” are defined as the type of a block.

If the received block is a start block in step S1103, the process proceeds to step S1104.

If the received block is a service block in step S1103, the process proceeds to step S1108.

If the received block is a branch block in step S1103, the process proceeds to step S1113.

If the received block is a source code block in step S1103, the process proceeds to step S1118.

If the received block is an end block in step S1103, the process proceeds to step S1119.

In step S1104, the service management unit 511 defines a variable for the request property related to the request (the request for provision of a service from the end-user terminal 40) submitted this time.

In step S1105, the service management unit 511 performs validation (verification) of the request property.

In step S1106, the service management unit 511 determines whether a problem occurs in the validation.

If a problem occurs in the validation, it is determined that the determination result is YES in step S1106, and the process proceeds to step S1107.

If no problems occur in the validation, it is determined that the determination result is NO in step S1106, and the process proceeds to step S1116.

In step S1107, the service management unit 511 performs an error process. Examples of the error process include transmission of an error message such as a message indicating that an inexecutable service has been requested, to the end-user terminal 40.

After step S1107, the service providing process ends. In step S1108, the service management unit 511 specifies a service, which is to be executed, on the basis of the received block data.

In step S1109, the service management unit 511 generates request data for the server which provides the service.

In step S1110, the service management unit 511 transmits the generated request data to the server which provides the service.

In step S1111, the service management unit 511 sets the result (request result), which is obtained in response to the request, to a variable.

In step S1112, the service management unit 511 determines a block that is to be executed next, in accordance with the request result.

After step S1112, the service management unit 511 causes the process to proceed to step S1116.

In step S1113, the service management unit 511 obtains a branch condition from the branch block.

In step S1114, the service management unit 511 determines whether the current status satisfies the obtained branch condition.

If the current status does not satisfy the obtained branch condition, it is determined that the determination result is NO in step S1114, and the process proceeds to step S113.

If the current status satisfies the obtained branch condition, it is determined that the determination result is YES in step S1114, and the process proceeds to step S1115.

In step S1115, the service management unit 511 determines a block that is to be executed next, in accordance with the satisfied condition.

In step S1116, the service management unit 511 specifies a block that is to be executed next.

In step S1117, the service management unit 511 gives, to the function which is being executed, the specified block as an argument.

After step S1117, the process proceeds to step S1102.

In step S1118, the service management unit 511 executes source codes defined in the block.

After step S1118, the process proceeds to step S1116.

In step S1119, the service management unit 511 defines a variable for the response property related to the request submitted this time.

In step S1120, the service management unit 511 determines the status code (HTTP response status code) of the response.

In step S1121, the service management unit 511 transmits the response, which indicates the execution result of the service providing process, to the end-user terminal 40.

After step S1121, the service providing process ends.

Thus, the information processing system 1 according to the embodiment described above enables a service flow to be designed in such a manner that component blocks constituting the service are arranged on the operator/administrator terminal 30. Pages representing designed service flows are selectable on the end-user terminal 40. When a page is selected on the end-user terminal 40, the page corresponding to the service is drawn.

The drawn page is used as a user interface to execute the components constituting the service sequentially, achieving implementation of the business logic represented by the designed service flow.

Therefore, the information processing system 1 enables a series of target services to be constructed without creation of program codes for implementing the services.

As described above, the information processing system 1 according to the present embodiment provides services in cooperation with the cloud systems 70-1 to 70-n. The information processing system 1 includes the component providing server 60, the operator/administrator terminal 30, and the service providing server 50.

The component providing server 60 accumulates elements included in pages for providing services on the cloud systems 70-1 to 70-n.

The operator/administrator terminal 30 is used to create pages for new services by using elements accumulated in the component providing server 60.

The service providing server 50 executes programs associated with elements included in pages.

Thus, in construction of a page for providing a new service, elements necessary for the service are selected and embedded in the page, enabling simple and flexible construction of the page for the necessary service.

Therefore, the functions provided by an information processing system may be constructed rapidly and flexibly.

The information processing system 1 includes the widget development terminal 20.

The widget development terminal 20 is used to create new elements.

The component providing server 60 further accumulates elements created on the widget development terminal 20.

Thus, newly created elements may be selected and used in future creation of an element.

The information processing system 1 includes the service development terminal 10.

The service providing server 50 accumulates programs for services corresponding to elements.

The service development terminal 10 is used to create programs for services corresponding to new elements, by using the programs accumulated in the service providing server 50.

The service providing server 50 further accumulates programs created on the service development terminal 10.

Thus, a program for a service, which corresponds to an element for which a program is not accumulated in the service providing server 50, may be created, and the new element may be added to the selection targets.

In elements, parameters for implementing services are settable, and actions, which are performed when pages are viewed, are defined.

Thus, elements may be embedded in pages in such a manner that necessary parameters are set, and that actions, which are performed when the pages are viewed, are changed appropriately.

Programs are cloud native programs which are executed in the cloud systems 70-1 to 70-n through application program interfaces.

Thus, elements embedded in pages may be implemented as cloud native applications.

The service providing server 50 obtains history data about viewing pages.

The service providing server 50 analyzes the obtained history data, and proposes new services.

Thus, new services, which are highly likely to be needed, may be proposed on the basis of the data obtained through provision of services.

The present invention is not to be limited to the above-described embodiment. Various changes, modifications, etc. are also covered by the present invention as long as such changes, modifications, etc. fall in a range in which the object of the present invention can be achieved.

For example, the system configuration of the information processing system 1 in the embodiment described above is exemplary. As long as the functions of the information processing system 1 are implemented as a whole, the service providing server 50 and the component providing server 60 may be implemented as a single server, or the functions of the service providing server 50 and the component providing server 60 may be distributed to more servers for implementation.

Services in the embodiment described above may be assumed mainly as services or micro services in a cloud native system, and may include other services like these.

The processing sequence described above can be executed by hardware, and can also be executed by software.

In other words, the functional configuration in the embodiment described above is merely exemplary, and is not particularly limited. That is, any configuration may be employed as long as a function, which enables the series of processes described above to be performed as a whole, is included in any computer included in the information processing system 1. What kinds of functional blocks are used to implement this function is not limited to the example described specifically.

A single functional block may be configured by a single piece of hardware, a single installation of software, or a combination thereof.

A recording medium including a program for performing the series of processes described above is configured not only by using a removable medium, which is distributed separately from the apparatus body to provide the program to a user, but also, for example, by using a recording medium provided to a user in a state in which the recording medium is pre-installed in the apparatus body.

As described above, the embodiment of the present invention is described. The present invention is not limited to the embodiment described above. The effects described in the present embodiment are merely a list of the most preferable effects produced from the present invention. The effects of the present invention are not limited to those described in the present embodiment.
1 information processing system, 10 service development terminal, 20 widget development terminal, 30 operator/administrator terminal, 40 end-user terminal, 50 service providing server, 60 component providing server, 70-1 to 70-n cloud systems, 80 network, 800 information processing apparatus, 811 CPU, 812 ROM, 813 RAM, 814 bus, 815 input unit, 816 output unit, 817 storage unit, 818 communication unit, 819 drive, 820 image capture unit, 831 removable medium, 111, 211, 311, 411 UI controller, 112, 212, 312, 412 management unit, 511 service management unit, 512 data analysis unit, 513 service proposing unit, 521 service development repository, 522 service repository, 523 history database, 611 component-data management unit, 612 page-data management unit, 621 widget repository, 622 content repository, 623 medium repository, 624 component development repository, 625 page repository

1. An information processing system providing services in cooperation with a cloud system, the information processing system comprising:
a processor which is configured to execute:
an element accumulation processing of accumulating an element displayed in a page for providing a service on the cloud system;
a page-data generating processing of generating a page for a new service by using the element accumulated by the element accumulation processing;
an element-program execution processing of executing a program associated with the element included in the page;
an element generating processing of generating a new element displayed on the page;
a program accumulation processing of accumulating the program for a service corresponding to the element; and
a program generating processing of generating a program for a service corresponding to the new element, the generating being performed by using the program accumulated by the program accumulation processing,
wherein the element includes a dynamic element causing the element's display in the corresponding page to be changed through execution of the program associated with the element,
wherein the element accumulation processing further accumulates the element generated by the element generating processing, and
wherein the program for the service corresponding to the dynamic element is developed separately from the dynamic element, accumulated, and stored, and when the dynamic element is developed, the stored program is selected and associated with the dynamic element such that the dynamic element is operable to provide the service of the selected program that is associated therewith.
